(19) United States
(12) Patent Application Publication
(10) Pub. No.: US 2025/0301295 A1
(43) Pub. Date: Sep. 25, 2025

(54) SYSTEM AND METHOD FOR SHARING INFORMATION WITH EMERGENCY SERVICE AGENCIES

(71) Applicant: Eagle Eye Networks, Inc., Austin, TX (US)

(72) Inventors: Dean Drako, Austin, TX (US); Tijmen Vos, Amsterdam (NL)

(73) Assignee: Eagle Eye Networks, Inc., Austin, TX (US)

(21) Appl. No.: 18/610,096

(22) Filed: Mar. 19, 2024

(51) Int. Cl. H04W 4/90; H04W 4/02; H04W 12/08

(52) U.S. Cl. CPC H04W 4/90; H04W 4/023; H04W 12/08

(57) ABSTRACT

Embodiments comprise a data center with one or more servers configured to receive a communication from an emergency service agency and respond with information. The communication may include a geo-location identifier, wherein embodiments identify a set of devices based on proximity to the emergency event location and that have been preselected to allow information sharing. Information may be shared to only a selected emergency service agency server and for a limited time period. Any access to information is recorded in an audit log viewable by the end user.

### BACKGROUND

### Field of the Disclosure

The present invention relates to providing information to emergency service agencies during an emergency situation, and particularly to providing information from sensors, cameras and other devices to emergency service agencies during an emergency situation.

### Description of the Related Art

Devices such as sensors may be used to detect environmental information (e.g., the presence of smoke or that something is moving). Devices including advanced sensors, microphones and cameras may capture information. For example, a thermal sensor may capture thermal information (e.g., the temperature inside a room or the presence of a person), a microphone may capture audio information (e.g., a person talking) and a camera may capture information (e.g., a person moving in a room).

### SUMMARY

Embodiments disclosed herein may be directed to a system for providing emergency service agencies and personnel access to information associated with an emergency event, wherein the information may be provided by a device and may comprise environmental information (e.g. temperature, the presence of smoke) and/or event-specific information (e.g., a video stream from a camera, sensor readings from a sensor, and/or audio information from a microphone). The information may include live information and/or historical information.

Embodiments disclosed herein may be directed to a system for determining a device associated with an emergency event and providing an emergency service agency with limited access to information from the device. The limited access may refer to a period for accessing the information, a period of information that can be accessed, an emergency service agency authorization and/or a geographic location.

Embodiments disclosed herein may be directed to a system for providing an emergency service agency with access to a device based on the device being associated with an emergency event.

Embodiments disclosed herein may be directed to a system for geolocation matching of a device or a group of devices with an emergency event.

Embodiments disclosed herein may be directed to a system for providing a location and azimuth or orientation of a device based on the device being associated with an emergency event.

Embodiments disclosed herein may be directed to a system for providing a name, a scene or other information associated with a device based on the device being associated with an emergency.

Embodiments disclosed herein may be directed to a system for providing an emergency service agency with a map and/or a floorplan associated with an emergency.

Embodiments may be generally directed to a system and method that enables emergency services agencies to request access to private cameras and other sensors. Embodiments may provide live and recorded images and information from a location (e.g., on a campus, in a building, on a street, etc.).

Embodiments may be generally directed to a method for sharing information with emergency service agencies. The method may comprise receiving information from a plurality of devices; receiving a communication indicating an emergency event; determining one or more devices corresponding to a user location within a proximity of an emergency event location corresponding to the emergency event; determining if each device in the one or more devices is available for sharing; and sharing information from the set of shareable devices with an emergency service agency server. In some embodiments, determining if each device in the one or more devices is available for sharing comprises if a device of the one or more devices is available for sharing, adding the device to a set of shareable devices, or if a device of the one or more devices is not available for sharing, not adding the device to the set of shareable devices.

In some embodiments, the user system communicates with the data center through a first Application Programming Interface (API) and the emergency service agency server communicates with the data center through a second API separate from the first API. In some embodiments, the method comprises receiving, from the user system, a device sharing authorization for a device associated with the user location over the first API, wherein determining if each device in the one or more device is available for sharing comprises determining if each device is online and has a corresponding device sharing authorization. In some embodiments, determining one or more devices corresponding to a user location within a proximity of an emergency event location comprises determining one or more of the user location, a device location and an address is within a distance of the emergency event location. In some embodiments, determining one or more devices corresponding to a user location are within a proximity of an emergency event location comprises determining one or more of the user location of one or more cameras and the emergency event location are both within a same building, on a same floor in the same building, on a same street and on a same route. In some embodiments, sharing information from the set of shareable cameras with an emergency service agency server comprises determining an emergency event start time; determining a device sharing end time; and determining a present time, wherein if the present time is less than the device sharing end time, sharing the information with the emergency service agency server; and if the present time is equal to or greater than the device sharing end time, stop sharing the information with the emergency service agency server.

Embodiments may be generally directed to a data center communicatively coupled to a plurality of devices and a plurality of user systems, wherein each device is associated with a user system of the plurality of user systems and each user system is associated with a user location, the data center comprising: a plurality of storage devices configured to receive information from the plurality of devices and store the information; and one or more servers executing a set of instructions to: receive a communication indicating an emergency event; determine one or more devices corresponding to a user location within a proximity of an emergency event location associated with the emergency event; determine if each device in the one or more devices is available for sharing, wherein if a device of the one or more devices is available for sharing, the one or more servers execute a set of instructions to add the device to a set of shareable devices, or if a device of the one or more devices is not available for sharing, the one or more servers execute a set of instructions to not add the device to the set of shareable devices; and share information from the set of shareable devices with an emergency service agency server.

In some embodiments, the user system communicates with the data center through a first Application Programming Interface (API) and the emergency service agency server communicates with the data center through a second API separate from the first API. In some embodiments, the one or more servers executes a set of instructions to receive a device sharing authorization for a device associated with the user location over the first API, wherein to determine if each device in the one or more devices is available for sharing, the one or more servers execute a set of instructions to determine if each device is online and has a corresponding device sharing authorization. In some embodiments, to determine one or more devices corresponding to a user location are within a proximity of an emergency event location, the one or more servers execute a set of instructions to determine whether one or more of the user location, a device location or an address of the one or more devices are within a distance of the emergency event location. In some embodiments, to determine one or more devices corresponding to a user location are within a proximity of an emergency event location, the one or more servers execute a set of instructions to determine one or more of whether the user location and the emergency event location are both within a same building, on a same floor in the same building, on a same street and on a same route. In some embodiments, to share information from the set of shareable devices with an emergency service agency server, the one or more servers execute a set of instructions to: determine an emergency event start time; determine a device sharing end time; and determine a present time, wherein if the present time is less than the device sharing end time, share the information with the emergency service agency server; and if the present time is equal to or greater than the device sharing end time, stop sharing the information with the emergency service agency server.

Embodiments may be generally directed to a system for sharing information with emergency service agencies, the system comprising: a plurality of devices, each device located at a user location and configured to transmit information corresponding to the user location; a data center comprising: a plurality of servers configured to: communicate with the plurality of devices to receive information associated with the user location and store the information, wherein the plurality of servers comprise one or more servers executing a set of instructions to: receive a communication indicating an emergency event; determine one or more devices corresponding to a user location within a proximity of an emergency event location corresponding to the emergency event; determine if each device in the one or more devices is available for sharing, wherein if a device of the one or more devices is available for sharing, the one or more servers execute a set of instructions to add the device to a set of shareable devices, or if a device of the one or more devices is not available for sharing, the one or more servers execute a set of instructions to not add the device to the set of shareable devices; and share information from the set of shareable devices with an emergency service agency server.

In some embodiments, the user system communicates with the data center through a first Application Programming Interface (API) and the emergency service agency server communicates with the data center through a second API separate from the first API. In some embodiments, the one or more servers executes a set of instructions to receive a device sharing authorization for a device associated with the user location over the first API, wherein to determine if each device in the one or more devices is available for sharing, the one or more servers execute a set of instructions to determine if each devices is online and has a corresponding device sharing authorization. In some embodiments, to determine one or more devices corresponding to a user location within a proximity of an emergency event location corresponding to the emergency event, the one or more servers execute a set of instructions to determine whether one or more of the user location, a device location, a device address of one or more cameras are within a distance of the emergency event location. In some embodiments, to determine one or more cameras corresponding to a user location within a proximity of an emergency event location corresponding to the emergency event, the one or more servers execute a set of instructions to determine one or more of if the user location of one or more cameras and the emergency event location are both within a same building, on a same floor in the same building, on a same street and on a same route. In some embodiments, to share information from the set of shareable devices with an emergency service agency server, the one or more servers execute a set of instructions to determine an emergency event start time; determine a device sharing end time; and determine a present time, wherein if the present time is less than the device sharing end time, the one or more servers execute a set of instructions to share the information with the emergency service agency server; and if the present time is equal to or greater than the device sharing end time, the one or more servers execute a set of instructions to stop sharing the information with the emergency service agency server.

To further clarify the above and other advantages and features of the present invention, a more particular description of the invention will be rendered by reference to specific embodiments thereof that are illustrated in the appended drawings.

### BRIEF DESCRIPTION OF DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system architecture of one embodiment of a network for smart video intelligence;

FIGS. 2-7 depict embodiments of user systems for capturing information from devices associated with user locations;

FIG. 8 is a diagram of an information handling system configurable for processing and storing information from devices associated with user locations;

FIG. 9 is a floorplan associated with a location, illustrating the position and orientation of a set of devices for capturing information associated with a user location;

FIG. 10 is a front view of a mobile device configured for displaying information received from the set of devices of FIG. 9;

FIG. 11 is a table illustrating one embodiment of a data structure storing information for the set of devices of FIG. 9;

FIG. 12 depicts a system architecture of one embodiment of a system for sharing information with an emergency response agency;

FIG. 13 depicts a flow diagram, illustrating a method for sharing information with an emergency response service;

FIG. 14 depicts a flow diagram, illustrating a method for determining a set of devices for sharing information with an emergency response service; and

FIG. 15 depicts a flow diagram, illustrating a method for limiting how long information is shared with an emergency response service based on a time period.

### DETAILED DESCRIPTION OF THE INVENTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that particular class/type or any one instance of that class/type in general.

Call centers for emergency response services (e.g., 911 centers) can often identify the location of an emergency event but depend on the caller to provide other information about the emergency event.

### System Overview

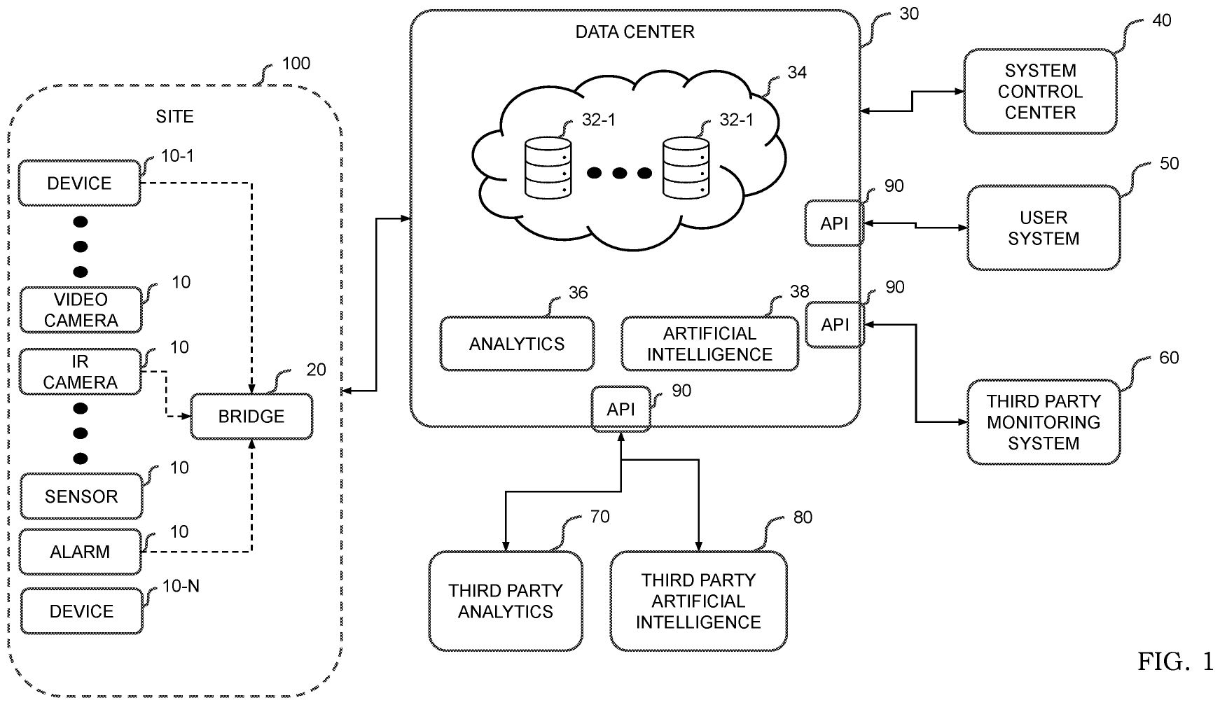

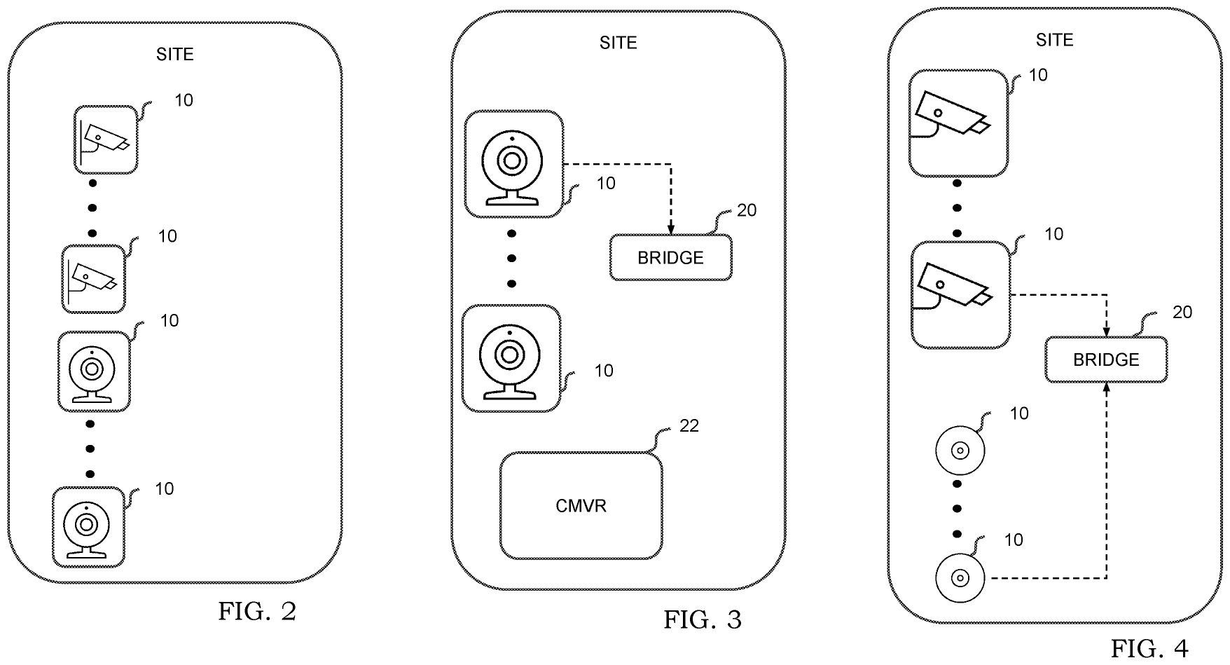

Turning to FIG. 1 and one or more of FIGS. 2-7, a system architecture of embodiments disclosed herein may comprise a plurality of devices 10 at a user location 100 communicatively coupled to data center 30. User location 100 may refer to a structure (e.g., a building or a group of buildings) or an area (including a group of areas).

### Devices

Devices 10 may comprise analog and/or digital (e.g., Internet Protocol or “IP”) devices 10 for capturing information relating to an environment, including, but not limited to, thermal sensors 10, audio sensors 10, light sensors 10, and motion sensors 10.

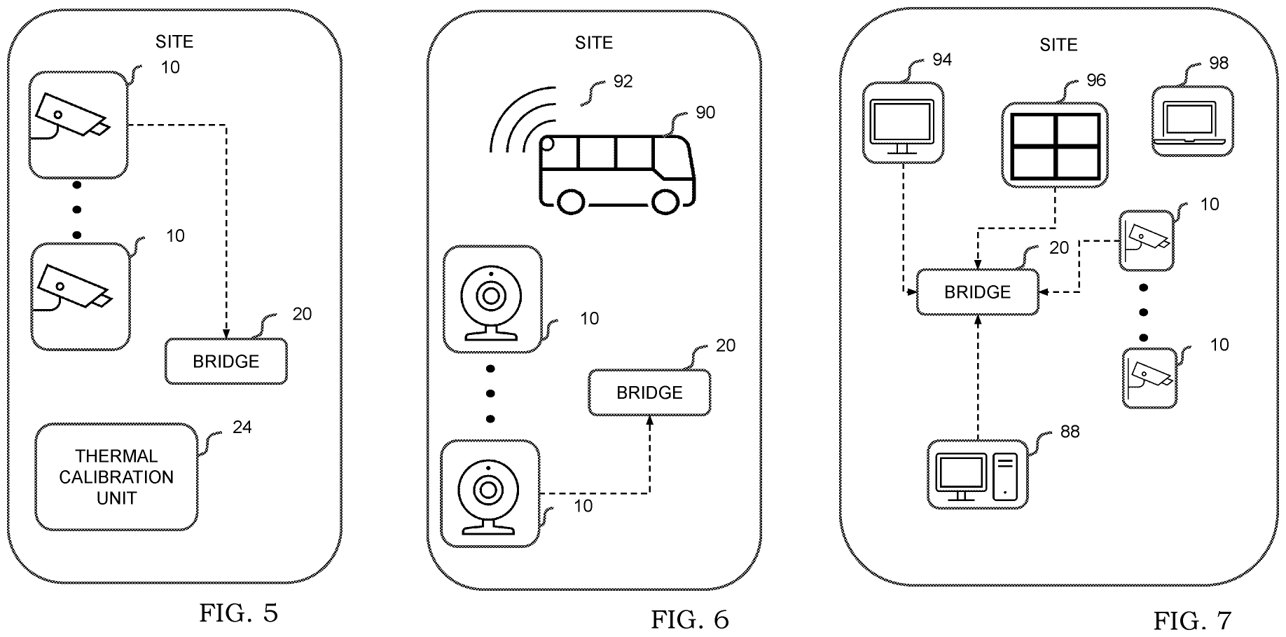

Devices 10 may further comprise cameras 10 including, but not limited to, directional cameras 10, 360-degree cameras 10, fish-eye cameras 10, black-and-white video cameras 10, color cameras 10, high resolution cameras 10, low-resolution cameras 10 and/or infrared cameras 10 for capturing video information. One or more devices 10 may comprise proprietary devices 10 associated with Eagle Eye Networks, Inc. of Austin, Texas. In some embodiments, one or more devices 10 may be manufactured by a third-party enterprise. Devices 10 may be located inside or outside a structure (e.g., an office building, a school or a warehouse) or near an area (e.g., near elevators or an entrance to a building, near a playground, in a park or in a parking lot). Referring to FIG. 5, embodiments may include calibration units 24 such as thermal calibration unit 24 for thermal sensors 10. Referring to FIG. 6, in some embodiments, devices 10 and/or bridge 20 may be located in vehicle 90 with mobile network device 92 configured to communicate with data center 30 over a network (e.g., cellular or Wi-Fi).

Devices 10 may be selected and positioned to capture information. For example, a thermal sensor 10 may be selected and positioned to detect a fire, a motion sensor 10 may be positioned to detect any movement, a 360-degree camera 10 may be selected and positioned near an elevator or in a room to capture information relating to movement of people, a directional camera 10 may be positioned and directed toward a door to capture information relating to movement of people through the door or positioned and directed toward a gate to capture information relating to movement of vehicles through the gate. In some embodiments, communicatively coupling device 10 to data center 30 may comprise a direct connection, wherein device 10 communicates information directly to data center. In other embodiments, communicatively coupling device 10 to data center 30 may comprise an indirect connection, wherein device 10 communicates information to bridge 20 (represented by dashed lines) and bridge 20 communicates the information to data center 30. Notably, one or more devices 10 at user location 100 may communicate information directly to data center 30 and one or more devices 10 may communicate information indirectly to data center 30.

Data center 30 may refer to a plurality of servers or other information handling systems configured for processing and storing information. Embodiments of data center 30 may comprise a plurality of data storage servers 32, wherein data storage servers 32 may be collectively referred to as cloud 34. Data storage servers 32 may store information received from devices 10. In some embodiments, data center 30 may be configured to store information received from a single device 10 of the plurality of devices 10 in at least three separate data storage servers 32 for redundant storage. Data center 30 may comprise analytics server 36 and artificial intelligence (AI) server 38, discussed in greater detail below.

Processing information may include, but is not limited to, receiving information, applying a time/date stamp, associating a user location with device 10 providing the information, associating a user identifier with device 10 providing the information, associating a geolocation with device 10 providing the information, associating device information with device 10 providing the information and associating a map or floorplan with device 10. Processing the information may also include applying artificial intelligence (AI) to the information and/or analyzing the information to determine a make, model, signature or description of a vehicle, determine a number and/or signature of one or more people associated with the information and determine one or more of a movement of a person, a movement of a part of a person or a gesture. Data center 30 may comprise a single site or may comprise a collection of sites such that information received from devices 10 may be received, processed and stored in a set of servers located at a single site or at multiple sites. Data center 30 may be communicatively coupled to system management center 40, one or more user systems 50 and one or more monitoring systems 60. Data center 30 may also be communicatively coupled to third party analytics server 70 and/or third-party artificial intelligence (AI) server 80. User systems 50, third-party monitoring systems 60, third-party analytics servers 70 and third-party AI servers 80 may be communicatively coupled to data center 30 through Application Programming Interfaces (APIs) 90.

### Bridges

Embodiments of bridge 20 may receive information from devices 10 and communicate the information to data center 30. Information may include, for example, a temperature reading, a sound level, a video stream and/or information about device 10 associated with the information. In some embodiments, bridge 20 may receive information from one or more devices 10 and directly communicate the information to data center 30. In some embodiments, bridge 20 may receive information from one or more devices 10 and analyze or process at least a portion of the information before communicating the information to data center 30. In some embodiments, bridge 20 may receive information from one or more devices 10 and store at least a portion of the information before communicating the information to data center 30. Thus, communicatively coupling devices 10 to bridges 20 and communicatively coupling bridges 20 to data center 30 may refer to directly or indirectly communicating information from devices 10 to data center 30, communicating information from devices 10 through bridges 20 to data center 30, and/or analyzing, processing or storing at least a portion of the information before communicating the information to data center 30. Embodiments of bridge 20 may be configured to communicate information to data center 30 in real-time, based on time (e.g., at scheduled intervals or at a scheduled time) or based on an event (e.g., in response to a predefined trigger).

Bridges 20 may buffer information in case the Internet connection fails. In some embodiments, bridge 20 does the encryption, data de-duplication, bandwidth management, motion analysis, and compression of information. In some embodiments, user location may include Cloud Managed Video Recorder (CMVR) 22, which may also provide on premise storage. In some embodiments, CMVR 22 may allow an end user to select how much information is sent to the cloud, and how much is stored on premise.

Referring to FIG. 7, in some embodiments, user location 100 may comprise spot monitor 94, large wall display 96 and/or local viewing device 98 for localized review and third-party analytics 88 for on-site processing of information as the information is captured.

### Data Center Information Processing

In some embodiments, information processing may comprise analyzing information from one or more devices 10. For example, information may include determining a manufacturer of device 10, an accuracy of device 10, a minimum threshold (e.g., minimum sound level, illumination or temperature) associated with device 10, a maximum threshold (e.g., maximum temperature, sound level or illumination) associated with device 10, a resolution of camera 10, a frame per second (FPS) processing speed of camera 10, a latency of device 10, a transmission protocol, or some other information associated with the capabilities of device 10 for recording and transmitting information. Device information may also include, for example, information on a location of device 10, wherein location information may include absolute information (e.g., geo-positioning system or GPS information) and/or relative location information (e.g., “the north stairwell”). Device information may include, for example, azimuth or orientation information, wherein orientation information may comprise absolute information (e.g., angled at 45 degrees horizontally and −25 degrees vertically) and/or relative information (e.g., “angled towards the stairwell and looking down”). Device information may include, for example, a time, a date and/or other information to identify where and when information was captured. Device information may include network information, such as an Internet Protocol (IP) address and/or an alias (e.g., “the main lobby camera”).

### Information Handling Systems

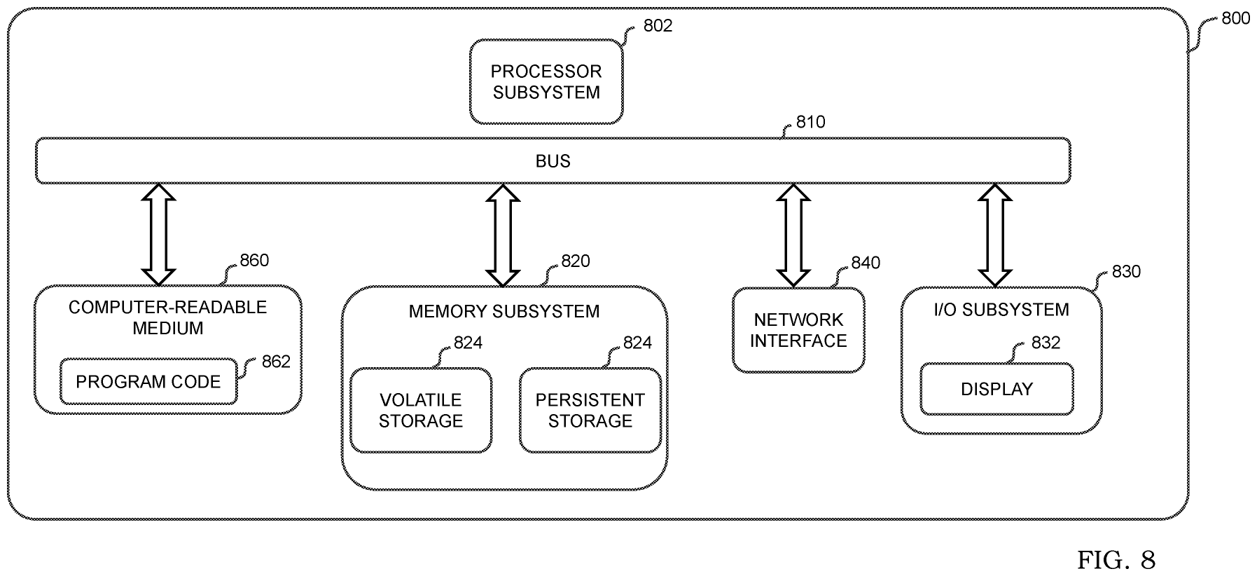

Referring to FIG. 8 and one or more of FIGS. 1, 6 and 7, data center 30, system control center 40, user system 50, third-party systems 60, third-party analytics 70 and third-party artificial intelligence (AI) systems 80 may comprise embodiments of information handling systems 800. FIG. 8 depicts an information handling system 800 capable of administering several of the embodiments of the present disclosure. Information handling system 800 may include processor subsystem 802 communicatively coupled via system bus 810 to memory subsystem 820, input/output (I/O) subsystem 830 and network interface 840.

Processor subsystem 802 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 802 may interpret and execute program instructions and process data stored locally (e.g., in memory subsystem 820). In the same or alternative embodiments, processor subsystem 802 may interpret and execute program instructions and process data stored remotely (e.g., in a network storage resource). Processor subsystem 802 may include components such as a central processing unit (GPU) and a graphics processing unit (GPU).

System bus 810 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 820 may comprise a system, device, or apparatus operable to retain and retrieve program instructions and data for a period of time (e.g., computer-readable media). Memory subsystem 820 may comprise one or more volatile storage 824 and persistent storage 826. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 830 may comprise a system, device, or apparatus generally operable to receive and transmit data to or from or within information handling system 800. I/O subsystem 830 may represent, for example, a variety of communication interfaces, graphics interfaces, video interfaces, user input interfaces, and peripheral interfaces. In various embodiments, I/O subsystem 830 may be used to support various peripheral devices, such as a touch panel, a display adapter, a keyboard, an accelerometer, a touch pad, a gyroscope, or a camera, among other examples. In some implementations, I/O subsystem 830 may support so-called ‘plug and play’ connectivity to external devices, in which the external devices may be added or removed while information handling system 800 is operating. In some embodiments, information handling system 800 may further include display 832. Display 832 may be of a variety of display types, such as a liquid crystal display (LCD), an organic light emitting diode (OLED), a flat panel display, a solid-state display, or a cathode ray tube (CRT). Display 832 may include one or more touch screen display modules and touch screen controllers for receiving user inputs to information handling system 800. Additionally, information handling system 800 may include an input device, such as a keyboard, and a cursor control device, such as a mouse or touchpad or similar peripheral input device.

Network interface 840 may be a suitable system, apparatus, or device operable to serve as an interface between information handling system 800 and a network (not shown). Network interface 840 may enable information handling system 800 to communicate over the network using a suitable transmission protocol or standard. In some embodiments, network interface 840 may be communicatively coupled via the network to a network storage resource (not shown). The network coupled to network interface 840 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 840 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 840 or various components associated therewith may be implemented using hardware, software, or any combination thereof.

Still referring to FIG. 8, computer program product 860 may comprise computer-readable media 870 storing program code 862. Program code 862 may be loaded onto or transferred to information handling system 800 for running by processor subsystem 802.

A Set of Devices May be Associated with a User Location

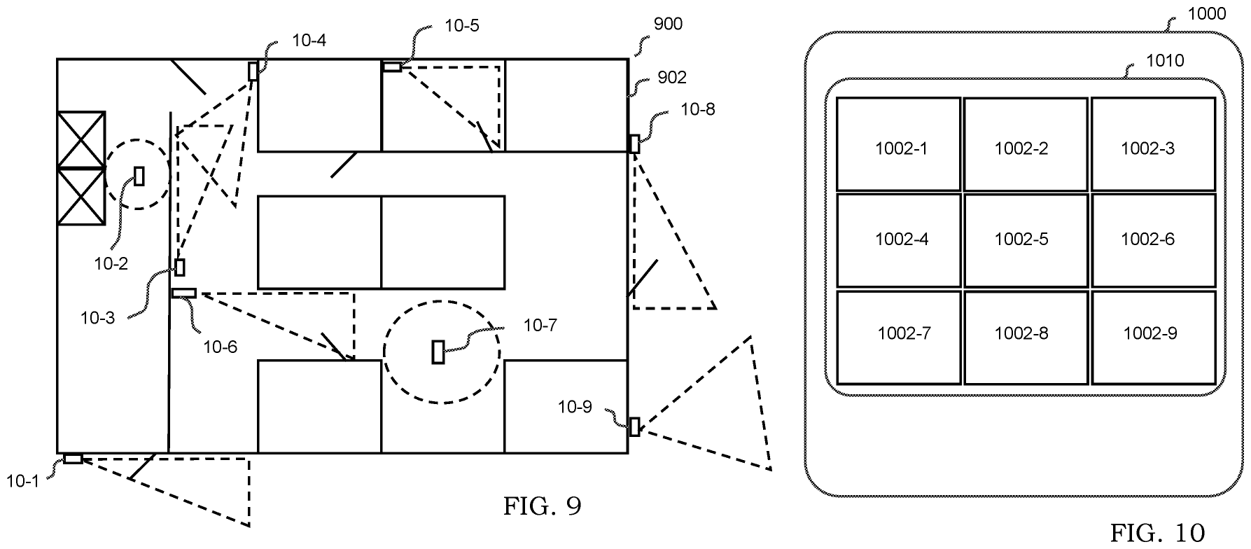

Turning to FIG. 9, embodiments allow devices 10 to provide information relative to a location 900 (represented by floorplan 902) to user systems 50. As depicted in FIG. 9, a plurality of devices 10 may be positioned at a location, wherein the number and type of devices 10 may depend on characteristics of the location and user preferences. For example, a location associated with location 900 may have nine associated devices 10-1 to 10-9, wherein devices 10-1 and 10-8 may be motion sensors, device 10-2 may be a 360-degree camera, device 10-7 may be a temperature sensor and devices 10-3 to 10-6 and 10-9 may be directional cameras 10.

A User Device May be Capable of Displaying Information from a Set of Devices

FIG. 10 depicts a front view of user device 1000 with display 1010 configured to display information from devices 10-1 to 10-9 shown in FIG. 9. As depicted in FIG. 10, there may be a plurality of portions 1002 (sometimes referred to as affordances) of display 1010 for displaying information based on devices 10 selected by a user of computing device 10. Computing device 1000 may be configured to display information from a particular device (e.g., device 10-1) in a particular affordance (e.g., affordance 1002-1).

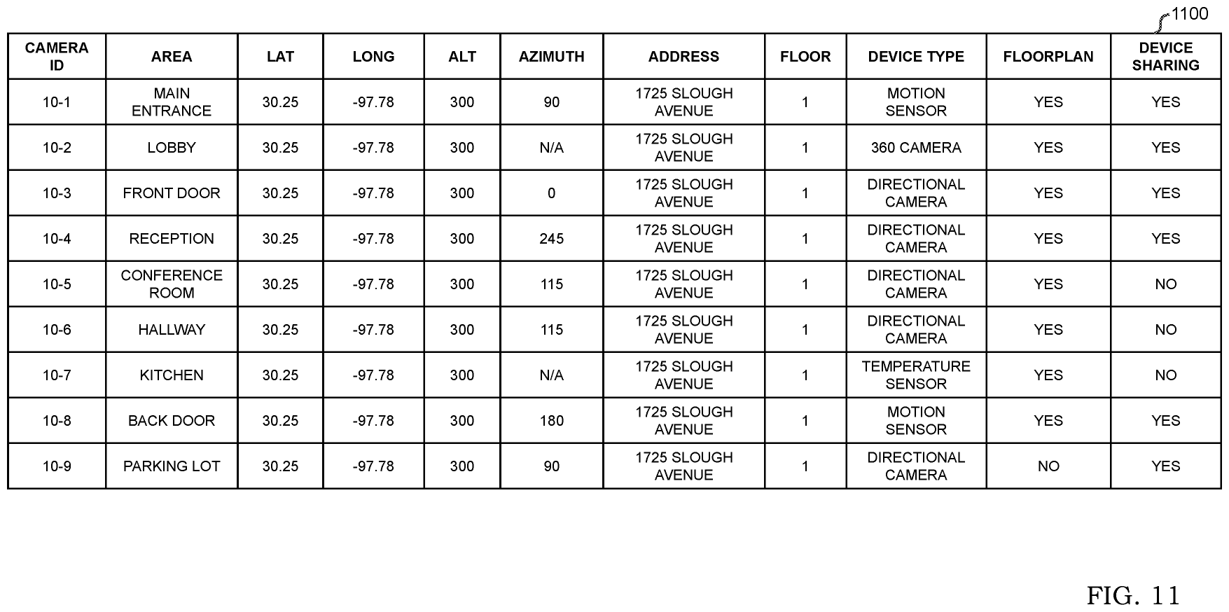

FIG. 11 depicts a data structure 1100 containing information for each device 10 associated with a user location 900. As shown in FIG. 11, data structure 1100 may be a table with rows and columns, wherein each row contains information for one device 10 and a plurality of columns store device information about the device 10. Data structure 1100 may contain device information such as a device identifier, an area associated with device 10, geolocation information, an address associated with the user location, a floor identifier, a device type, a floorplan and/or map indicator and an indicator of whether device 10 is available for sharing information. Geolocation information may include absolute geolocation information (e.g., latitude, longitude and altitude) or relative geolocation information (e.g., main entrance, conference room). A device type indicator may associate a device 10 with a type of device (e.g., temperature sensor, motion sensor, sound sensor, 360-degree camera, fisheye camera, directional camera, outdoor camera, lighted camera, etc.). A floorplan and/or map indicator may associate a device 10 with a floorplan 902 or a map (not shown) stored in data center 30. A device sharing indicator may refer to a value or flag associated with allowing or preventing information from a particular device 10 being shared with emergency response service systems (discussed in greater detail below).

Embodiments disclosed herein enable end users to allow emergency service agencies to access information from devices 10 and enable emergency service agencies (ESAs) to view information from devices 10.

Sharing Information with Emergency Response Services

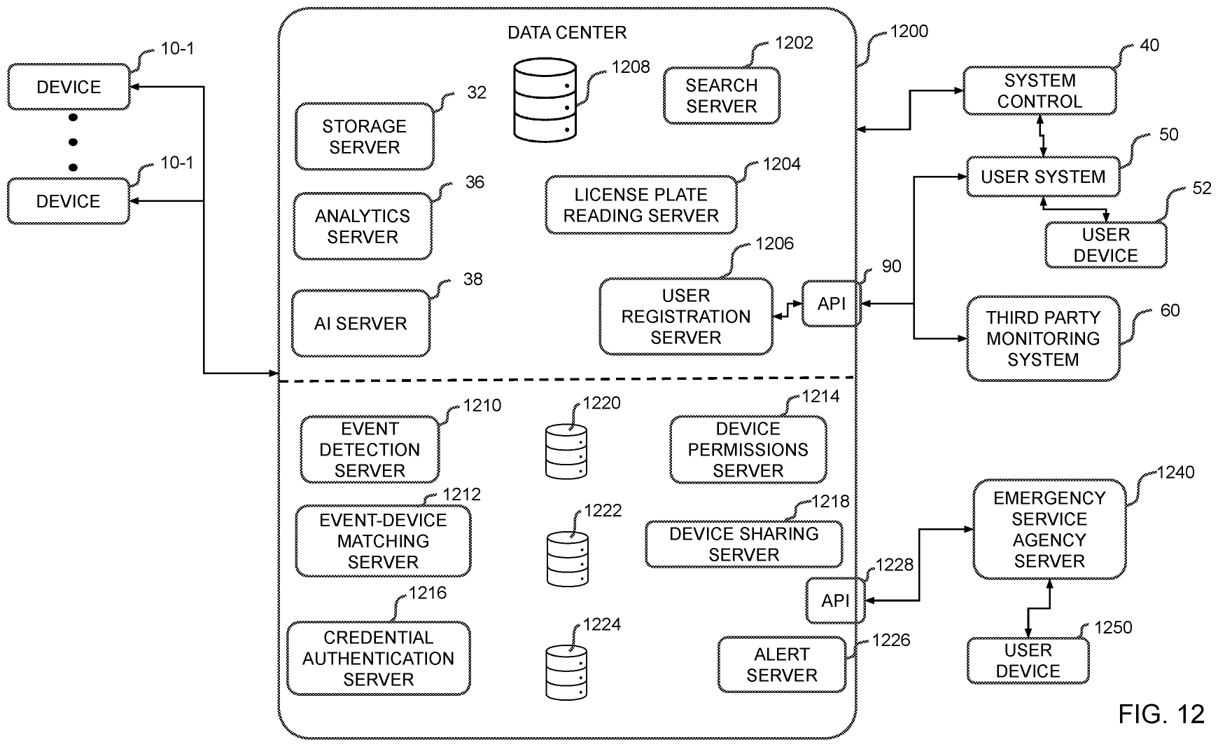

Referring to FIG. 12, data center 1200 may comprise a plurality of servers (e.g., memory servers 32, analytics server 36 and AI server 38 as discussed with respect to FIG. 1) and further comprise license plate reading server 1202 search server 1204 user registration server 1306 and audit log repository 1208, all accessible by user systems 50 (including user devices 52) and third-party monitoring system 60 through Application Programming Interfaces (APIs) 90.

One or more of analytics server 36 and AI server 38 may determine when device 10 is detecting or recording relevant information and store the information in servers 32. Search server 1202 may execute a set of instructions to access the information and search the information (e.g., determine information about a person, which may include what the person is wearing, if the person is carrying something (e.g., a backpack or briefcase), if the person is moving or stationary, if the person is standing, sitting, kneeling or lying down, if the person is gesturing, etc). License plate reading service (LPRS) server 1204 may execute a set of instructions to determine information about a vehicle (e.g., determine that a vehicle has a license plate and read the license plate information). Other information (e.g., a temperature reading, a sound level measurement or a video stream of a person or vehicle), a time of day, a location of the device 10 associated with the information, information about a person or vehicle may be stored in storage servers 32.

User registration server 1206 may execute a set of instructions to allow a user of user system 50 to register one or more devices 10 to enable emergency service agencies (ESAs) to access and/or view information or prevent anyone from accessing or viewing information. In some embodiments, a user associated with user system 50 may interact with user registration server 1206 through API 90. The user may select an option for device sharing, wherein the user can select a device 10 associated with user system 50 and provide a flag or value to indicate whether the device 10 may be available for sharing information. In some embodiments, a location for a device 10 may be determined and stored with the device sharing indicator. In some embodiments, user registration server 1206 may store device information including device sharing information and a user location and floorplan or map associated with device 10 in device permissions repository 1220.

Audit log repository 1208 may store information related to user systems 50 and third-party monitoring systems 60 accessing data center 1200, including details related to what information was accessed, including which video streams were viewed, what user system 50 accessed information (including which devices 10 and a user who accessed the information) saved in storage servers 32.

### Emergency Service Agencies

Emergency service agencies (ESAs) may refer to entities responsible for responding to emergency events. An ESA may respond to only a single type of emergency event or may respond to multiple types of emergency events. An ESA may correspond to emergency events at a particular level (e.g., international events, national events, federal events, regional events, state events, county (including parishes or boroughs) events, municipality (including cities, towns, villages, etc.) events) or portions thereof. An ESA may respond to a type of emergency event (e.g., a fire, an accident, a hostage situation). However, an ESA (e.g. a sheriff's department) associated with one type of emergency event (e.g., a hostage situation) in one jurisdiction (e.g., Texas) would not typically respond to an emergency event that is a different type (e.g., a fire) or in another jurisdiction (e.g., California). Even for larger agencies such as federal ESAs (e.g., the FBI, ATF, FEMA), a local office in one jurisdiction would not typically respond to an emergency event in a different jurisdiction covered by a different local office. Furthermore, not all ESA personnel will need access to information for every emergency event. For example, ESA personnel may be miles away from an emergency event, may be responding to another event or may be off-duty.

### Responding to an Emergency Event

As used herein, the term “emergency event” may refer to an event in which a response is considered time-critical and/or associated with an emergency service agency. A person may call an emergency service response center (e.g., a 911 call center) and talk to an emergency service agent (e.g., a 911 call operator) sitting at a console, which may be an information handling system (e.g., a client computer) executing a set of instructions for displaying a browser and communicatively coupled to a server executing instructions to determine a location of the caller. emergency response systems typically provide an address and a description of the event to emergency response personnel but may provide little else. Furthermore, people calling in to report an emergency event may be stressed and/or confused such that they provide inaccurate or conflicting information. Embodiments disclosed herein may provide emergency service agencies with one or more live video streams to enable emergency response personnel to more accurately assess the situation and provide a more appropriate response.

Embodiments may provide access by an emergency service agency to video streams and other information from a set of devices 10 that an end user has authorized to allow sharing, wherein each sharable device 10 may be selected based on proximity to the emergency event 10 and the emergency event is associated with the emergency service agency. Embodiments may also provide device information and a floorplan to enable emergency service agencies to determine which device 10 is providing the information and where the device 10 is capturing the information.

An end user associated with user system 50 may designate which devices 10 may share information, for how long, at what times of day, and any other restrictions. A user may designate one or more (including all) devices 10 associated with a location may share information or may not allow any devices 10 to share information. A user may allow one or more (including all) devices 10 to share information only on certain days (e.g., weekends) or during certain times (e.g., between 5 P.M. and 6 A.M.) or other restrictions. Preauthorizing selected devices 10 for sharing information may reduce the length of time needed for emergency service agencies to access information from devices 10 during emergency events.

Referring still to FIG. 12, data center 1200 may comprise event detection server 1210, event-device matching server 1212, device permissions server 1214, credential authentication server 1216, device sharing server 1218, credentialing repository 1220, floorplan repository 1222, device permissions information repository 1224, alert server 1226, authentication repository 128, floorplan repository and audit log repository 1230.

Event detection server 1210 may execute instructions to determine when an emergency event has occurred. In some embodiments, determining when an emergency event has occurred comprises communicating with an external server (e.g., emergency service agency server 1240). For example, embodiments may be notified of an emergency event by receiving a request for information from emergency service agency server 1240. In some embodiments, determining when an emergency event has occurred comprises communicating with a third-party system and receiving a signal or communication associated with an emergency event. For example, embodiments may receive a signal associated with a user activating a fire alarm in a building and associate the signal with an emergency event.

Event-device matching server 1212 may execute instructions to match an event with a user location having one or more devices 10. In some embodiments, event-device matching server 1212 may receive a communication indicating an emergency event, the communication containing geo-location information (e.g., GPS coordinates) associated with the emergency event. Event-device matching server 1212 may use geo-location information and the emergency event information to identify a set of devices 10 based on one or more of the event and proximity of a device 10 or user location associated with device 10 to the event location. Proximity may refer to an absolute proximity based on distance (e.g., 500 meters in any direction from the event location), based on a route (e.g., five blocks of a street along a route), based on a relationship with the event location (e.g., a lobby in a building may be determined to be within a proximity of any floor in the same building) or some other proximity (e.g., two streets on either side of a street, two floors above and/or below a floor associated with an event in a building), or some combination. Proximity may be based on whether the emergency event is associated with a person (with limited total range and limited speed but capable of travelling up and/or down a flight of stairs and moving between small areas) or a vehicle (with a larger range and capable of higher speeds but more limited in routes).

### Device Permissions

Device permissions server 1214 may execute instructions to determine if a device 10 is available for sharing information. In some embodiments, device permissions server 1214 may determine, based on a device sharing indicator stored in memory, that a set of devices 10 is available for sharing. In some embodiments, device permissions server 1214 may communicate with user registration server 1206 or device permissions repository 1224 to determine a set of devices 10 that are available for sharing.

Accordingly, credential authentication server 1216 may execute instructions to determine if an emergency service agency server 1240 and/or an emergency service agency user device 1250 should be authorized to access or view information shared by data center 1200. In some embodiments, credential authentication server 1216 may determine an event location associated with a particular emergency event and an agency location or jurisdiction associated with emergency service agency server 1240 requesting access to information associated with the particular emergency event and either allow emergency service agency server 1240 to access and/or view information or prevent emergency service agency server 1240 from accessing or viewing information. In some embodiments, credential authentication server 1216 may determine an event type associated with a particular emergency event and a response capability associated with emergency service agency server 1240 requesting access to information associated with the particular emergency event and either allow emergency service agency server 1240 to access and/or view information or prevent emergency service agency server 1240 from accessing or viewing information. In some embodiments, credential authentication server 1216 may determine an event location associated with a particular emergency event and a user location associated with ESA user device 1250 requesting access to information associated with the particular emergency event and either allow ESA user device 1250 to access and/or view information or prevent ESA user device 1250 from accessing or viewing information.

Device sharing server 1218 may execute instructions to share video, sensor values and other information from a set of devices 10 with emergency service agency server 1240 and/or a set of emergency service agency user devices 1250 based on each device 10 being identified as a shareable device 10 and being within a proximity of the emergency event and the emergency service agency server 1240 and/or an emergency service agency user device 1250 being authenticated and associated with an emergency service agency user who needs to access or who may benefit from viewing information associated with the emergency event.

Credentialing repository 1220 may store credentials and other information related to an emergency service agency. For example, an emergency service agency may register emergency service agency server 1240 with data center 1200 to allow emergency service agency server 1240 to access API 1228. Once an emergency service agency server 1240 is registered with data center 1200, credentialing repository 1220 may store information about the emergency service agency server 1240, such as what types of emergency events the emergency service agency responds to and what geographic areas the emergency service agency covers.

Floorplan repository 1222 may store floorplan information for a user location, wherein a floorplan may be a simple floorplan defining the boundaries of a location or may be more detailed, such as including the location of one or more devices 10, distances, doors, windows and other exits, rooms, closets and/or shelter-in-place locations, stairs, elevators, first aid kits, fire extinguishers, automated external defibrillator (AED) devices and any other information that may assist an emergency service agency response team assess a situation.

Device permissions information repository 1224 may store device permissions information including, for example, a data structure of devices 10 and their permissions and/or a data structure of devices 10 that are available for sharing. The data structure may be, for example, a table data structure or may be a floorplan with an overlay.

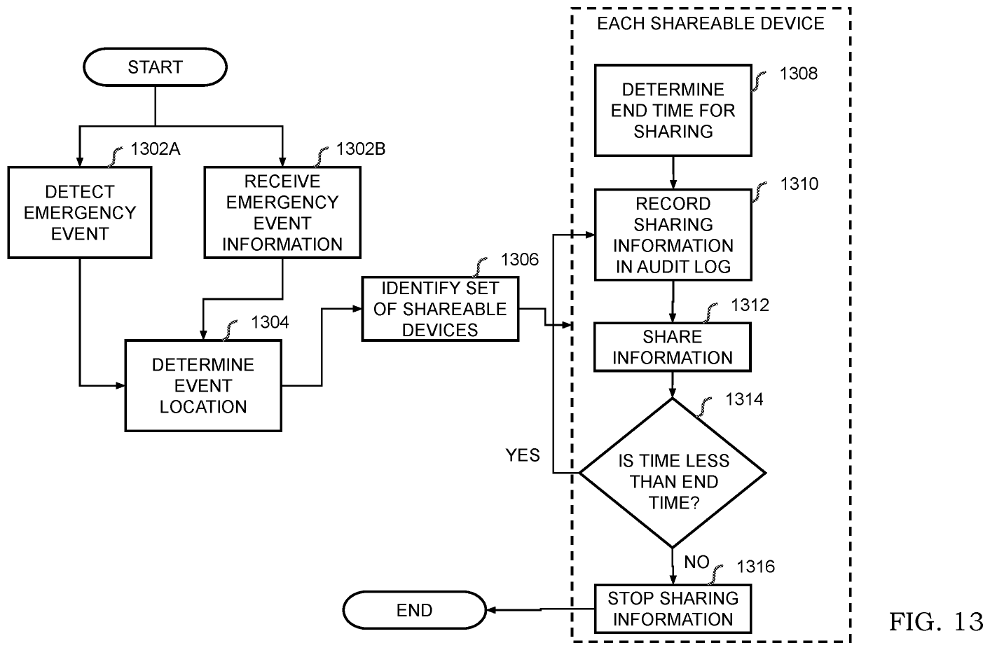

Referring to FIG. 13, embodiments may include a method of sharing information with authorized ESA service providers.

As step 1302, embodiments may determine an emergency even has occurred. In some embodiments, determining an emergency event has occurred comprises step 1302A of detecting an emergency event (e.g., determining a fire alarm has been activated). In some embodiments, determining an emergency event has occurred comprises step 1302B of receiving emergency event information (e.g., receiving a request from ESA server 1250, wherein the request includes an indicator that an emergency event has occurred.

At step 1304, embodiments may determine an emergency event location.

At step 1306, embodiments may identify a set of shareable cameras for sharing information.

At step 1308, embodiments may determine an end time for sharing information. For example, embodiments may determine an end time may be four hours after an emergency event has occurred.

At step 1310, embodiments may record what information is shared in an audit log. Shared information may include what devices 10 were selected for sharing, when the sharing began, whether historical information was shared, how long the information was shared, what emergency service agency server 1240 or user device 1250 accessed the information, and other information.

At step 1312, embodiments may share information with an emergency service agency server 1240 and/or an emergency service agency user device 1250. In some embodiments, only live information is shared. In other embodiments, historical information (including historical video streams) and/or a floorplan may be shared, which may assist emergency service agency personnel in assessing the emergency event.

At step 1314, embodiments may determine if the present time has exceeded an end time for sharing information. If the present time has not exceeded the end time for sharing information, then embodiments may continue performing steps 1310-1314 until the time exceeds the end time for sharing information.

At step 1316, embodiments may stop sharing information. For example, credential authentication server 1216 may revoke any permissions provided to emergency service agency server 1240, camera permissions server 1214 may revoke any permissions associated with devices 10 and/or credential authentication server 1216 may revoke any permissions provided to device sharing server 1218.

### Identifying Shareable Devices

Selecting a set of shareable devices 10 may comprise determining that a device 10 is relevant to an emergency event location and that the device 10 is available for sharing information.

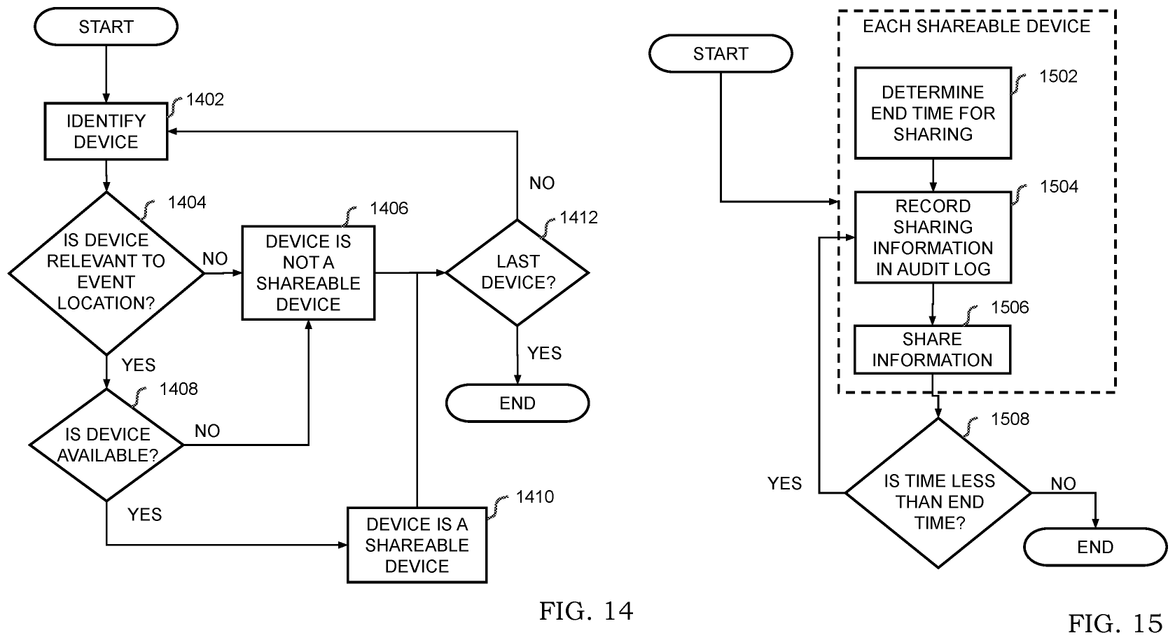

Referring to FIG. 14, a method for determining a set of shareable devices 10 may begin when an emergency event location is determined.

At step 1402, embodiments may identify a device 10 from a plurality of devices 10.

At step 1404, embodiments may determine if device 10 is relevant to the camera location. In some embodiments, event-device matching server 1208 may determine if device 10 or a user location associated with device 10 is within proximity of an emergency event location. For example, if an emergency event location is associated with a building, event-device matching server 1208 may determine if device 10 is on the same floor in the building, is on an adjacent floor in the building, corresponds to a lobby of the building or is located outside the building but oriented toward or near the building or a parking lot associated with the building. Event-device matching server 1208 may also identify one or more devices 10 on a street next to an emergency event location. Event-device matching server 1208 may further determine if device 10 is online. In some embodiments, and device 10 not online and/or not transmitting information is not added (or removed) from any list of shareable devices 10.

If embodiments determine device 10 is not relevant to an emergency event location, then at step 1406, device 10 is determined to not be a shareable device 10.

If embodiments determine device 10 is relevant to an emergency event location, then at step 1408, embodiments determine if device 10 is available for sharing. In some embodiments, device permissions server 1214 may determine, for each device 10 considered relevant to the emergency event, whether device 10 is online and whether the end user associated with the device 10 has enabled device 10 to provide information to ESAs. Determining if device 10 is available may also include determining any restrictions on the use of device 10. For example, a user may designate that device 10 may be shared after normal business hours and on weekends, such that device 10 is available after hours and on weekends, but not during normal business hours.

If device 10 is not available, then at step 1406, device 10 is determined to not be a shareable device 10.

If device 10 is available, then at step 1410, device 10 is determined to be a shareable device 10.

At step 1412, embodiments may determine if device 10 is the last device 10 being considered for sharing. For example, in a scenario in which there are twenty-five devices 10 within a proximity of an emergency event, embodiments may repeat steps 1402-1408 twenty-five times.

### Limiting Access to Shareable Devices

A user may allow emergency service agencies to access or view information to assist with assessing an emergency event situation and developing a more appropriate response, but may not want to provide unlimited access to information. Embodiments disclosed herein may limit access to information by emergency service agencies based on time.

FIG. 15 depicts a flow diagram illustrating a method for limiting access to information based on time.

At step 1502, embodiments may determine an end time for sharing information. For example, embodiments may receive information that an emergency event started at a first time (e.g., 2 pm.) and determine an end time should be four hours later (e.g., 6 p.m.). An end time may be based on the emergency event (e.g., location, type of emergency, etc.), or based on end user restrictions on device 10 (e.g., the end user selected a time limit of four hours to share information). In some embodiments, an emergency service agency may request historical information (e.g, video information 30 minutes prior to the event) to better understand what happened. Thus, if there is a four hour end time but the emergency service agency requests 30 minutes prior to the event, embodiments may provide 30 minutes of historical information and four hours of live information.

At step 1504, embodiments may record device sharing information in audit log 1208. Device sharing information may include, for example, which devices 10 were accessed, which emergency service agency accessed devices 10 and how long information from devices 10 was shared.

At step 1506, embodiments share information with emergency service agency server 1240. In some embodiments, information is shared via API 1228, which is separate from API 90 such that only emergency service agency server 1240 is able to access information from devices 10 that an end user has opted to enable sharing.

At step 1508, embodiments determine if a time is less than an end time. In some embodiments, an end time may be an absolute time (e.g., 6:00 P.M.). In some embodiments, an end time may be a relative time (e.g., four hours). If the time is less than the end time, embodiments may continue recording sharing information in audit log 1208 and sharing information. If the time is equal to or greater than the end time, embodiments stop sharing information.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method for sharing information with emergency service agencies, the method comprising:
receiving information from a plurality of devices;
receiving a communication indicating an emergency event;
determining one or more devices corresponding to a user location within a proximity of an emergency event location corresponding to the emergency event;
determining if each device in the one or more devices is available for sharing, wherein
if a device of the one or more devices is available for sharing, adding the device to a set of shareable devices, or
if a device of the one or more devices is not available for sharing, not adding the device to the set of shareable devices; and
sharing information from the set of shareable devices with an emergency service agency server.

2. The method of claim 1, wherein the user system communicates with the data center through a first Application Programming Interface (API) and the emergency service agency server communicates with the data center through a second API separate from the first API.

3. The method of claim 1, further comprising receiving, from the user system, a device sharing authorization for a device associated with the user location over the first API, wherein determining if each device in the one or more device is available for sharing comprises determining if each device has a corresponding device sharing authorization.

4. The method of claim 1, wherein determining one or more devices corresponding to a user location within a proximity of an emergency event location comprises determining one or more of the user location, a device location and an address is within a distance of the emergency event location.

5. The method of claim 4, wherein determining one or more devices corresponding to a user location are within a proximity of an emergency event location comprises determining one or more of the user location of one or more cameras and the emergency event location are both within a same building, on a same floor in the same building, on a same street and on a same route.

6. The method of claim 1, wherein sharing information from the set of shareable cameras with an emergency service agency server comprises:
determining an emergency event start time;
determining a device sharing end time; and
determining a present time, wherein
if the present time is less than the device sharing end time, sharing the information with the emergency service agency server; and
if the present time is equal to or greater than the device sharing end time, stop sharing the information with the emergency service agency server.

7. A data center communicatively coupled to a plurality of devices and a plurality of user systems, wherein each device is associated with a user system of the plurality of user systems and each user system is associated with a user location, the data center comprising:
a plurality of storage devices configured to receive information from the plurality of devices and store the information; and
one or more servers executing a set of instructions to:
receive a communication indicating an emergency event;
determine one or more devices corresponding to a user location within a proximity of an emergency event location associated with the emergency event;
determine if each device in the one or more devices is available for sharing, wherein
if a device of the one or more devices is available for sharing, the one or more servers execute a set of instructions to add the device to a set of shareable devices, or
if a device of the one or more devices is not available for sharing, the one or more servers execute a set of instructions to not add the device to the set of shareable devices; and
share information from the set of shareable devices with an emergency service agency server.

8. The data center of claim 7, wherein the user system communicates with the data center through a first Application Programming Interface (API) and the emergency service agency server communicates with the data center through a second API separate from the first API.

9. The data center of claim 7, wherein the one or more servers executes a set of instructions to receive a device sharing authorization for a device associated with the user location over the first API, wherein, to determine if each device in the one or more devices is available for sharing, the one or more servers execute a set of instructions to determine if each device has a corresponding device sharing authorization.

10. The data center of claim 7, wherein to determine one or more devices corresponding to a user location are within a proximity of an emergency event location, the one or more servers execute a set of instructions to determine whether one or more of the user location, a device location or an address of the one or more devices are within a distance of the emergency event location.

11. The data center of claim 10, wherein to determine one or more devices corresponding to a user location are within a proximity of an emergency event location, the one or more servers execute a set of instructions to determine one or more of whether the user location and the emergency event location are both within a same building, on a same floor in the same building, on a same street and on a same route.

12. The data center of claim 7, wherein to share information from the set of shareable devices with an emergency service agency server, the one or more servers execute a set of instructions to:
determine an emergency event start time;
determine a device sharing end time; and
determine a present time, wherein
if the present time is less than the device sharing end time, share the information with the emergency service agency server; and
if the present time is equal to or greater than the device sharing end time, stop sharing the information with the emergency service agency server.

13. A system for sharing information with emergency service agencies, the system comprising:
a plurality of devices, each device located at a user location and configured to transmit information corresponding to the user location;
a data center comprising:
a plurality of servers configured to:
communicate with the plurality of devices to receive information associated with the user location and store the information, wherein the plurality of servers comprise one or more servers executing a set of instructions to:
receive a communication indicating an emergency event;
determine one or more devices corresponding to a user location within a proximity of an emergency event location corresponding to the emergency event;
determine if each device in the one or more devices is available for sharing, wherein
if a device of the one or more devices is available for sharing, the one or more servers execute a set of instructions to add the device to a set of shareable devices, or
if a device of the one or more devices is not available for sharing, the one or more servers execute a set of instructions to not add the device to the set of shareable devices; and
share information from the set of shareable devices with an emergency service agency server.

14. The system of claim 13, wherein the user system communicates with the data center through a first Application Programming Interface (API) and the emergency service agency server communicates with the data center through a second API separate from the first API.

15. The system of claim 13, wherein the one or more servers executes a set of instructions to receive a device sharing authorization for a device associated with the user location over the first API, wherein, to determine if each device in the one or more devices is available for sharing, the one or more servers execute a set of instructions to determine if each devices has a corresponding device sharing authorization.

16. The system of claim 13, wherein to determine one or more devices corresponding to a user location within a proximity of an emergency event location corresponding to the emergency event, the one or more servers execute a set of instructions to determine whether one or more of the user location, a device location, a device address of one or more cameras are within a distance of the emergency event location.

17. The system of claim 16, wherein to determine one or more cameras corresponding to a user location within a proximity of an emergency event location corresponding to the emergency event, the one or more servers execute a set of instructions to determine one or more of if the user location of one or more cameras and the emergency event location are both within a same building, on a same floor in the same building, on a same street and on a same route.

18. The system of claim 13, wherein to share information from the set of shareable devices with an emergency service agency server, the one or more servers execute a set of instructions to:
determine an emergency event start time;
determine a device sharing end time; and
determine a present time, wherein
if the present time is less than the device sharing end time, share the information with the emergency service agency server; and
if the present time is equal to or greater than the device sharing end time, stop sharing the information with the emergency service agency server.
